(19) United States
(12) Patent Application Publication
(10) Pub. No.: US 2026/0267854 A1
(43) Pub. Date: Sep. 10, 2026

(54) DATA ACQUISITION SYSTEM, METHOD, AND PROGRAM USING LANGUAGE MODEL

(71) Applicant: LG MANAGEMENT DEVELOPMENT INSTITUTE CO., LTD., Seoul (KR)

(72) Inventors: Chang Ho LEE, Seoul (KR); Min Woo LEE, Seoul (KR); Tae Gwan KANG, Seoul (KR); Won Kee LEE, Seoul (KR)

(21) Appl. No.: 19/663,240

(22) Filed: Apr. 29, 2026

Related U.S. Application Data
(63) Continuation of application No. PCT/KR2025/019440, filed on Nov. 21, 2025.

(30) Foreign Application Priority Data
Nov. 21, 2024 (KR) 10-2024-0167857
Nov. 20, 2025 (KR) 10-2025-0177000

(51) Int. Cl. G06F 16/2453; G06F 9/54; G06F 16/242

(52) U.S. Cl. CPC G06F 16/24535; G06F 9/54; G06F 16/243

(57) ABSTRACT

A system, a method, and a program using a language model perform operations comprising receiving a query generated based on a user query or a system event; analyzing a type of the query by a first language model; selecting, by the first language model, a search scope and at least one application programming interface (API) for obtaining real-time information according to the analyzed type of the query; requesting real-time data to the server using the selected API and obtaining the real-time data as an API response from the server; and generating and outputting a natural language response through a second language model using the API response.

### CROSS-REFERENCE TO RELATED APPLICATIONS

This application is a continuation of International Patent Application No. PCT/KR2025/019440, filed on Nov. 21, 2025, which claims the benefit of and priority to Korean Patent Application No. 10-2024-0167857, filed on Nov. 21, 2024, and Korean Patent Application No. 10-2025-0177000, filed on Nov. 20, 2025, the entire disclosures of which are hereby incorporated herein by reference in their entireties.

### TECHNICAL FIELD

The present disclosure generally relates to a system, method, and program for acquiring data using a language model.

### RELATED ART

Conventional large language models (LLMs) have a limitation in that reflecting real-time changing information or latest data is difficult due to their reliance on pre-trained static data. In particular, in areas such as web information that is updated moment by moment, latest events and current affairs, and professional fields requiring rapid updates, it may be difficult to provide accurate and timely responses with only the static knowledge base of existing LLMs.

As an attempt to solve such problems, a technology (WebGPT) that acquires external information in real time through web browser search and generates answers based thereon has been developed {Nakano, et al. “WebGPT: Browser-assisted question-answering with human feedback” (2022)}. The technology is designed to enable an LLM to perform browser actions such as searching, clicking links, scrolling, and selecting information so that the LLM directly explores Internet-based materials and generates more reliable answers using the same. Furthermore, by enabling an LLM to generate reference-based responses that reflect human preference feedback, it has partially resolved the problem of lack of information recency of existing LLMs.

However, the conventional WebGPT technology has a structural constraint in that the process of acquiring external information is limited to a single platform called the web. In other words, since a method for accessing external data is limited only to a web browser basis, flexible access to various external data sources (for example, cloud storage, private databases, in-house document repositories, other application programming interface (API)-based services, etc.) is difficult, and as a result, the information collection scope and usability of the LLMs are limited.

### SUMMARY

Some embodiments of the present disclosure may provide a system, method, program for acquiring data using a language model.

The technical problems to be solved by the present disclosure are not limited to the above-mentioned problems, and other problems that are not mentioned will be clearly understood by those skilled in the art from the following description.

A system for acquiring data using a language model according to the present disclosure may include: at least one memory storing instructions; at least one processor executing the instructions to perform an operation; and at least one server; wherein the operation performed by the instructions executed by the at least one processor may include: a step of receiving a query generated based on a user query or a system event; a step of analyzing a type of the query through a first language model; a step of selecting, through the first language model, a search scope and at least one application programming interface (API) for obtaining real-time information according to the analyzed type of the query; a step of requesting real-time data from the server using the selected API and obtaining the real-time data as an API response; and a step of generating and outputting a natural language response through a second language model using the API response.

In the system, the step of analyzing the type of the query may include enabling first language model to parse at least one of a keyword, a temporal expression, a data format requirement, and a task purpose included in the query and to categorize the query into at least one of a plurality of predefined query types.

In the system, the step of selecting the at least one API may include selecting an API corresponding to the type of the analyzed query by comparing the type of the analyzed query with at least one of a data format, an available data range, a response delay time, and an update cycle included in metadata provided by the API.

In the system, the step of requesting and obtaining real-time data from the server using the selected API may include enabling the first language model to generate an API request message by filling parameter values extracted from the query into an API call template of a predefined structured data format and to transmit the API request message to the server.

In the system, the step of analyzing the type of the query may include, when the query is analyzed as including at least one sub-query, analyzing a type for each of the sub-queries included in the query; and the step of selecting the at least one API may include selecting the at least one API for each of the sub-queries; and the step of requesting the real-time data and obtaining the real-time data as an API response may include requesting the real-time data from the server by sequentially using the at least one API selected for each of the sub-queries.

In the system, using the API response may include: a step of evaluating similarity scores between a plurality of data fragments included in the API response and the query; a step of selecting the data fragments having the similarity scores greater than or equal to a predefined threshold; and a step of re-sorting the selected data fragments according to the similarity scores.

The system may further include a device including the processor and the memory, and the step of analyzing the type of the query includes classifying the query as at least one of an internal manipulation query requiring control of functions of the device or an external information query requiring acquisition of external data, when the query is classified as the internal manipulation query, the processor may control the functions of the device by calling an internal API corresponding to a command for controlling the device extracted from the query, and when the query is classified as the external information query, a step of selecting a search scope and at least one API for obtaining the real-time information, a step of requesting real-time data from the server and obtaining an API response, and a step of generating and outputting a natural language response through the second language model may be performed.

In the system, the command for controlling the device may include at least one of device power control, screen brightness adjustment, volume adjustment, communication setting change, and application execution.

A method of acquiring data using a language mode of the present disclosure may include: a step of receiving a query generated based on a user query or a system event; a step of analyzing a type of the query through a first language model; a step of selecting, through the first language model, a search scope and at least one application programming interface (API) for obtaining real-time information according to the analyzed type of the query; a step of requesting real-time data from the server using the selected API and obtaining the real-time data as an API response; and a step of generating and outputting a natural language response through a second language model using the API response.

In the method, the step of analyzing the type of the query may include enabling the first language model to parse at least one of a keyword, a temporal expression, a data format requirement, and a task purpose included in the query and to categorize the query into at least one of a plurality of predefined query types.

In the method, the step of selecting the at least one API may include selecting an API corresponding to the type of the analyzed query by comparing the type of the analyzed query with at least one of a data format, an available data range, a response delay time, and an update cycle included in metadata provided by the API.

In the method, the step of requesting and obtaining real-time data from the server using the selected API may include enabling the first language model to generate an API request message by filling parameter values extracted from the query into an API call template of a predefined structured data format and to transmit the API request message to the server.

In the method, the step of analyzing the type of the query may include, when the query is analyzed as including at least one sub-query, analyzing a type for each of the sub-queries included in the query; and the step of selecting the at least one API may include selecting the at least one API for each of the sub-queries; and the step of requesting the real-time data and obtaining the real-time data as an API response may include requesting the real-time data from the server by sequentially using the at least one API selected for each of the sub-queries.

In the method, using the API response may include: a step of evaluating similarity scores between a plurality of data fragments included in the API response and the query; a step of selecting the data fragments having the similarity scores greater than or equal t o a predefined threshold; and a step of re-sorting the selected data fragments according to the similarity scores.

In the method, the step of analyzing the type of the query may include classifying the query as at least one of an internal manipulation query requiring control of functions of the device or an external information query requiring acquisition of external data, when the query is classified as the internal manipulation query, the processor may control the functions of the device by calling an internal API corresponding to a command for controlling the device extracted from the query, and when the query is classified as the external information query, a step of selecting a search scope and at least one API for obtaining the real-time information, a step of requesting real-time data from the server and obtaining an API response, and a step of generating and outputting a natural language response through the second language model may be performed.

In the method, the command for controlling the device may include at least one of device power control, screen brightness adjustment, volume adjustment, communication setting change, and application execution.

A program according to another aspect of the present disclosure may be stored on a computer-readable recording medium, in combination with a computer, for acquiring data using a language model according to embodiments of the present disclosure.

By including steps of receiving a query generated based on a user query or a system event, analyzing a type of the query by a first language model, selecting, by the first language model, a search scope and at least one application programming interface (API) for obtaining real-time information according to the analyzed type of the query, requesting real-time data to the server using the selected API and obtaining the real-time data as an API response from the server, and outputting a natural language response through a second language model using the API response, a computer system according to an embodiment of the present disclosure may provide more accurate and contextually appropriate real-time information with less computation resources by precisely analyzing the intent and information requirements inherent in user queries and comprehensively utilizing various external data environments (e.g., web search, map-based place information, weather information, code execution results, mathematical calculation results, etc.). Further, by parsing the keywords, temporal expressions, and task purposes of queries through the planner LLM to generate structured parameters and automatically setting search ranges that consider even temporal associations, enable users to obtain sophisticated data search and analysis results using only natural language without the need to directly specify complex search conditions or instructions. In addition, by having the first language model and the second language model cooperate to proceed from real-time data collection to natural language response generation, stably process various types of queries and provide integrated responses for both structured and unstructured data.

By including a step of, wherein the analyzing of the type of the query includes causing the first language model to parse at least one of a keyword, a temporal expression, a data format requirement, or a task purpose included in the query and to categorize the query into at least one of a plurality of predefined query types, a computer system according to an embodiment of the present disclosure may, by automatically converting user queries written in natural language into structured parameters and query types, improve the accuracy and efficiency of subsequent API selection and data processing with less computation resources, and further, by clearly distinguishing between supportable and unsupportable functions and selecting an appropriate processing path, perform a variety of service requests in a stable and consistent manner.

By including a step of, wherein the selecting of the at least one API includes selecting an API corresponding to the analyzed type of the query by comparing the analyzed type of the query with at least one of a data format, an available data range, a response delay time, or an update cycle included in metadata provided by the API, a computer system according to an embodiment of the present disclosure may automatically select the most suitable API for the data format and recency, information domain, and response speed required by the user's query, thereby reducing unnecessary API calls and enabling accurate and rapid real-time information acquisition, and further, by being based on matching between the semantic structure of the query and API metadata, stably select the optimal data source for various types of queries, improving overall data processing efficiency and response quality.

By including a step of, wherein the requesting of the real-time data to the server using the selected API includes causing the first language model to generate an API request message by filling parameter values extracted from the query into an API call template of a predefined structured data format and to transmit the API request message to the server, a computer system according to an embodiment of the present disclosure may, by automatically converting queries into structured API requests, enable real-time data acquisition that accurately reflects a user's query intention, and further, consistently perform extraction of query parameters, automatic completion of API call templates, and a server transmission process, thereby reducing or minimizing failures due to API selection errors or format mismatches and reliably supporting integration with various external data sources.

By including a step of, wherein the analyzing of the type of the query includes, when the query includes one or more sub-queries, analyzing a type for each of the one or more sub-queries included in the query; the selecting of the at least one API includes selecting the at least one API for each of the one or more sub-queries; and the requesting of the real-time data to the server includes requesting the real-time data to the server by sequentially using the at least one API selected for each of the one or more sub-queries, a computer system according to an embodiment of the present disclosure may stably acquire real-time data that is accurate and suitable for the purpose even in complex query structures, and further, organically process sub-queries while maintaining a step-by-step data flow even when there is a precedence dependency relationship between the sub-queries, thereby implementing an advanced data acquisition system that understands and executes a user's multi-step requirements.

By including a step of, wherein the outputting of the natural language response through the second language model using the API response includes evaluating similarity scores between a plurality of data fragments included in the API response and the query, selecting one or more data fragments having the similarity scores greater than or equal to a predefined threshold among the plurality of data fragments, and re-sorting the selected one or more data fragments according to the similarity scores, a computer system according to an embodiment of the present disclosure may effectively remove unnecessary information with low relevance to the user's query from the API response, so that the second language model can receive only core data that has been selected and sorted based on similarity, thereby generating accurate and contextually appropriate natural language responses.

By including a step of, wherein the analyzing of the type of the query includes classifying the query as at least one of an internal manipulation query requiring control of functions of the device or an external information query requiring acquisition of external data, and when the query is classified as the internal manipulation query, the system is configured to control the functions of the device by calling an internal API corresponding to a command for controlling the device extracted from the query, whereas when the query is classified as the external information query, the system is configured to select the search scope and the at least one API for obtaining the real-time information, request the real-time data to the server, and output the natural language response through the second language model, a computer system according to an embodiment of the present disclosure may perform not only simple setting changes but also complex manipulations with natural language commands alone.

By including a step of, wherein the command for controlling the device includes at least one of device power control, screen brightness adjustment, volume adjustment, communication setting change, or application execution, a computer system according to an embodiment of the present disclosure may enable a user to receive a universal service that can process various requirements of device function control and information retrieval using only natural language through a single interface.

The effects of the present disclosure are not limited to the above-mentioned effects, and other effects that are not mentioned will be clearly understood by those skilled in the art from the following description.

### BRIEF DESCRIPTION OF THE DRAWINGS

FIG. 1 is a schematic diagram illustrating a system for acquiring data using a language model according to an embodiment of the present disclosure.

FIG. 2 is a block diagram for explaining a configuration of an apparatus for acquiring data using a language model according to an embodiment of the present disclosure.

FIGS. 3A and 3B are a flowchart and a block diagram for explaining a method of acquiring data using a language model according to an embodiment of the present disclosure.

FIGS. 4A and 4B are a flowchart and a conceptual diagram for illustrating a process in which a first language model parses a query and classifies the type of the query to provide to a subsequent API selection step in a method for analyzing a type of the query through a first language model according to an embodiment of the present disclosure.

FIG. 5 is a flowchart for illustrating a process of selecting an API corresponding to the query type in a method for selecting a search scope and at least one API for acquiring real-time information based on the type of a query analyzed by a first language model according to an embodiment of the present disclosure.

FIG. 6 is a flowchart for illustrating a process of generating an API request message and transmitting the API request message to a server in a method for requesting real-time data from a server using a selected API to obtain an API response according to an embodiment of the present disclosure.

FIG. 7 is a flowchart for illustrating a process of obtaining real-time data from a server when an input query includes at least one sub-query by individually selecting an API for each sub-query and sequentially calling the API according to an embodiment of the present disclosure.

FIG. 8 is a flowchart illustrating a process of using an API response in a method in which a second language model generates a natural language response using the API response according to an embodiment of the present disclosure.

FIG. 9 is a flowchart for illustrating an operating procedure of a system that processes both internal manipulation queries requiring device function control and external information queries requiring external data acquisition according to an embodiment of the present disclosure.

FIGS. 10A to 10E show test results of verifying the effectiveness of an embodiment of the present disclosure.

### DETAILED DESCRIPTION OF EXEMPLARY EMBODIMENTS

The following embodiments are provided as examples to sufficiently convey the spirit of the present invention to those skilled in the art to which the present invention pertains. Therefore, the present invention is not limited to the embodiments described below and may be embodied in other forms.

Throughout the present disclosure, like reference numerals refer to like elements. The present disclosure does not describe all elements of the embodiments, and general content in the technical field to which the present invention pertains or overlapping content between embodiments is omitted. The terms “unit, module, member, block” used herein may be implemented as software or hardware, and according to embodiments, a plurality of “units, modules, members, blocks” may be implemented as one component, or one “unit, module, member, block” may include a plurality of components.

Throughout the specification, when a part is said to be “connected” to another part, this includes not only direct connections but also indirect connections, and indirect connections include connections through a wireless communication network.

In addition, when a part is said to “include” a component, this means that the part may further include other components rather than excluding other components, unless specifically stated to the contrary.

Throughout the specification, when an element is said to be positioned “on” another element, this includes not only the case where an element is in contact with another element, but also the case where yet another element is present between the two elements.

Singular forms include plural forms, unless the context clearly indicates otherwise.

The reference numerals in each step are used for convenience of description, and the reference numerals do not describe the sequence of each step, and each step may be performed in a different order than the stated order unless the context explicitly indicates a specific order.

A system for acquiring data using a language model according to an embodiment of the present disclosure may include a device. The device may include all of the various devices capable of performing operations and providing results to a user. For example, the system for acquiring data using a language model according to an embodiment of the present disclosure may include at least one of a computer, a server device, and a portable terminal, or may be any form performing the same or similar functions thereto, but the present disclosure is not limited thereto.

Here, the computer may include, for example, a laptop, a desktop, a tablet personal computer (PC), a slate PC, and the like equipped with a web browser.

The server device may be a server configured to perform communication with external devices to process information, and may include an application server, a computing server, a database server, a file server, a game server, a mail server, a proxy server, and a web server.

The portable terminal may include, for example, but not limited to, wireless communication devices that ensure portability and mobility, all types of handheld wireless communication devices such as personal communication system (PCS), global system for mobile communications (GSM), personal digital cellular (PDC), personal handyphone system (PHS), personal digital assistant (PDA), international mobile telecommunication (IMT)-2000, code division multiple access (CDMA)-2000, wideband code division multiple access (WCDMA), wireless broadband internet (WiBro) terminals, and smart phones and wearable devices such as watches, rings, bracelets, anklets, necklaces, glasses, contact lenses, and head-mounted devices (HMD).

Hereinafter, embodiments of the present invention will be described in detail with reference to the accompanying drawings.

Certain embodiments of the present disclosure relate to a system, method, and program for acquiring data using a language model.

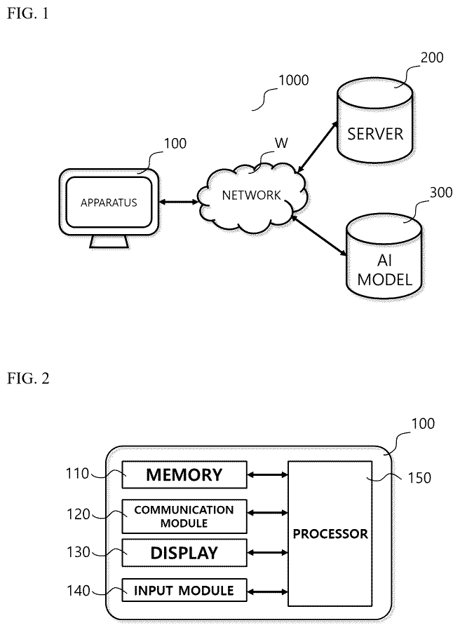

FIG. 1 is a schematic diagram for illustrating a system for acquiring data using a language model according to an embodiment of the present disclosure.

Referring to FIG. 1, a system 1000 may include a device 100, a server 200, and an artificial intelligence (AI) model 300. FIG. 1 illustrates an exemplary case where the AI model 300 is implemented outside of the device 100 or the server 200, but the present disclosure is not limited thereto. For example, the AI model 300 may be implemented as a component of the device 100 and/or the server 200.

The device 100, server 200, and AI model 300 included in the system 1000 may communicate through a network W. The network W may include a wired network and a wireless network. For example, the network may include various networks such as a local area network (LAN), a metropolitan area network (MAN), a wide area network (WAN), and the like.

In addition, the network W may also include a world wide web (WWW). However, the network W according to an embodiment of the present disclosure is not limited to the networks enumerated above, and may include at least in part a wireless data network, a telephone network, or a wired or wireless television network.

FIG. 1 illustrates an exemplary case where the server 200 is implemented external to the device 100. The server 200 may be connected to the device 100 by wire or wirelessly. However, this is merely one embodiment, and the server 200 may also be implemented as a component of the device 100.

FIG. 2 is a block diagram for explaining a configuration of a data acquisition device using a language model according to an embodiment of the present disclosure.

Referring to FIG. 2, the device 100 may include one or more memories 110, a communication module or communicator 120, a display 130, an input module or interface 140, and one or more processors 150. However, the device 100 is not limited thereto, and the device 100 may have software and hardware configurations modified, added, or omitted within the scope obvious to a person skilled in the art according to required operations. In addition, the device 100 may be replaced by a system, and the device 100 may be implemented as a plurality of devices, in which case each component included in the device 100 may be included in at least one of the plurality of devices.

The memory 110 may store data for supporting or performing various functions of the device 100, programs for operation of the processor 150, input/output data, a plurality of application programs or applications running on the device, data for operation of the device 100, instructions, and AI models. At least some of such application programs may be downloaded from an external server via wireless communication.

The memory 110 may include storage media of at least one type selected from a flash memory type, a hard disk type, a solid state disk (SSD) type, a silicon disk drive (SDD) type, a multimedia card micro type, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

In addition, the memory 110 may be separate from the device 100 and may include a database connected to the device 100 by wire or wirelessly.

The communication module 120 may include one or more components configured to perform communication with external devices, for example, may include at least one of a broadcast receiving module or receiver, a wired communication module or communicator, a wireless communication module or communicator, a short-range communication module or communicator, and a location information module.

The wired communication module may include various wired communication modules such as a LAN module, a WAN module, or a value added network (VAN) module, as well as various cable communication modules such as universal serial bus (USB), high definition multimedia interface (HDMI), digital visual interface (DVI), recommended standard 232 (RS-232), power line communication, or plain old telephone service (POTS).

The wireless communication module may include a Wi-Fi module, a wireless broadband module, as well as wireless communication modules supporting various wireless communication methods such as global system for mobile communication (GSM), CDMA, WCDMA, universal mobile telecommunications system (UMTS), time division multiple access (TDMA), long term evolution (LTE), 4G, 5G, 6G, and the like.

The display 130 displays or outputs information or data processed by the present device 100, data input or output through the AI model 300, and the like. In addition, the display 130 may display execution screen information of an application program (e.g., an application) running on the present device 100, or user interface (UI) and graphic user interface (GUI) information according to such execution screen information.

The input module 140 is configured to receive information input from a user, and when the user inputs information through an input module 140, the processor 150 may control an operation of the device 100 to correspond to the input information.

For instance, the input module 140 may include hardware-type physical keys (e.g., buttons, dome switches, jog wheels, jog switches, etc., located on at least one of a front surface, a rear surface, and side surfaces of the present device) and software-type touch keys. As an example, the touch key may include a virtual key, a soft key, or a visual key displayed on a touchscreen-type display 130 through software processing, or may include a touch key disposed on a portion other than the touchscreen. The virtual key or visual key may be displayed on the touchscreen in various forms, and may include, for example, a graphic, a text, an icon, a video, or a combination thereof.

The processor 150 may be implemented with a memory configured to store data for algorithms or programs reproducing algorithms for controlling the operation of components within the device 100 (including learning or execution of an AI model), and at least one processor configured to perform the above-described operation using the data stored in a memory. In this case, the memory and the processor may be implemented as separate chips, or may be implemented as a single chip.

In one embodiment, the system 1000 or device 100 according to an embodiment of the present disclosure may include at least one processor, and when including a plurality of processors, the plurality of processors may be included within different devices 100.

In addition, in order to implement various embodiments of the present disclosure described below on the device 100, the processor 150 may control any one or a combination of a plurality of the above-described components.

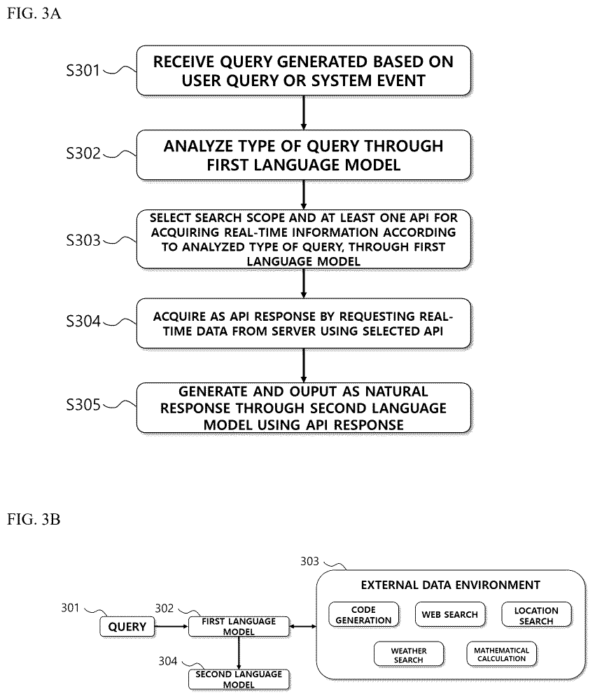

FIG. 3A is a flowchart for illustrating a method of acquiring data using a language model according to an embodiment of the present disclosure, and FIG. 3B is a block diagram for explaining a method of acquiring data using a language model according to an embodiment of the present disclosure.

At step S301, a query 301 generated based on a user query or a system event is received.

The query 301 may include various types of queries that occur in real-world environments, such as: “Can you write a simple data analysis code that can help me understand this scientific principle?”, “Please tell me where I can rent outdoor equipment in Gwangju.”, “What are the updated features in YOLO v5?”, and “Bianca worked 12.5 hours last weekend. Celeste worked twice that amount, and McClain worked 8.5 hours less than Celeste.” These queries may also include system events that occur automatically within the system or requests that are automatically generated by changes in internal device state, such as schedule occurrence, sensor data updates, battery status changes, network connection changes, etc. even when there is no user input. These queries have different purposes and information requirements, such as code generation requests, location information retrieval, latest technical information inquiry, or problem-solving requests that involve multi-step calculations.

At step S302, a type of the query 301 is analyzed through a first language model 302.

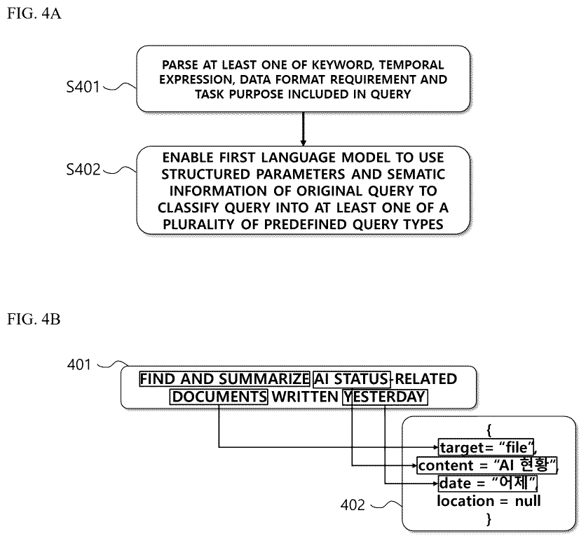

For instance, the first language model 302 may be configured as a planner large language model (LLM). Although the first language model 302 is described as distinct from a second language model 304 in an embodiment of the present disclosure, the present disclosure is not limited thereto, and the first language model and the second language model 302 and 304 may be implemented as a single language model. The first language model 302 infers the intent of the received natural language query 301, the nature of the required information, the need for real-time data, and the task steps included in the problem-solving process. In order to identify key concepts and requirements in the query 301, the planner LLM first divides the input natural language sentence into token units and estimates the part of speech, syntactic structure, and semantic role for each token. Subsequently, using pre-trained language model parameters and domain-specific vocabulary dictionaries, entities representing person, place, time, target object, task type, and the like are extracted within the query 301, and these entities are mapped to predefined semantic slots such as “requested task,” “target entity,” “attribute,” and “constraint.” For example, in the query 301, “What are the updated features of YOLO v5?”, “YOLO v5” may be identified as the target entity, “updated features” may be identified as the scope of the requested information, and “current time point” may be inferred as an implicitly suggested temporal constraint. In the query 301, “Please tell me where I can rent equipment for outdoor activities in Gwangju,” “rent equipment” is recognized as the task type (equipment rental search), “outdoor activities” as a constraint on the purpose of use, and “Gwangju” as a geographical location entity. In addition, the planner LLM detects temporal expressions such as “today,” “yesterday,” and “this year” and requirement level expressions such as “simple code” and “latest features” included in the query 301, converting them into internal representations such as “real-time data requirement,” “accuracy/detail level,” and “code generation necessity.” Through this process, the planner LLM classifies each query 301 into one or a plurality of types among predefined query types such as “code generation,” “location search,” “latest information retrieval through web search,” and “mathematical calculation,” while simultaneously extracting parameters necessary for processing the query 301 (e.g., target technology name, location information, time range, numerical values to be used in calculations) and reconstructing them into a structured query representation that may be utilized in subsequent API selection and calling steps (this will be described later with reference to FIG. 4). In this manner, the planner LLM identifies key concepts and requirements in the query 301 and determines through a reasoning process the environment in which the query 301 should be processed, such as code generation, location search, latest information retrieval, or mathematical calculation.

Additionally, as examples of query types analyzed through the first language model 302, there are simple type questions that ask about simple facts (e.g., When was LG AI Research founded?), compound type questions that are complex questions including comparison and analysis of multiple entities (e.g., Who has won more Ballon d'Or awards, Ronaldo or Messi?), multi-hop type questions that require stepwise search of multiple pieces of information to solve a question (e.g., What's Messi's former team's current rank in the league?), aggregation type questions that need to be answered by comprehensively inferring from retrieved content (e.g., How many Ballon d'Or awards did Ronaldo win until 2021?), creative writing type questions that require writing based on creativity (e.g., Write a story where a tiger and a rabbit become best friends despite their differences.), business analysis type questions for business analysis (e.g., Conduct a SWOT analysis for Tesla in the current EV market.), real-time type questions that require reflection of facts that have changed over time (e.g., What is the current stock price of Apple?), style transform type questions that request answers in a specific format or style (e.g., Explain quantum physics to me as if I were a 5-year-old.), false premise type questions based on incorrect assumptions (e.g., Why did the sun rise in the west today?), domain-specific type questions about specific fields (LG, medicine, law, etc.) (e.g., What are the potential side effects of this medication according to medical guidelines?), tool shifting type questions that induce the use of tools not previously used as the conversation continues (e.g., (After asking attractions in Seoul by WebQA) Can you check the weather of Seoul tomorrow?), topic shifting type questions that have shifted to a different topic from the previous conversation (e.g., (After discussing Messi's recent match performance) By the way, what are the best books to read this year?), and implicit follow-up type questions that require understanding the conversational context and the intent of the question by referring to content that appeared in previous conversations (e.g., (After discussing Messi's stats) How many goals did he score last season?), but the present disclosure is not limited thereto.

At step S303, through the first language model 302, according to the analyzed type of the query 301, a search scope for obtaining real-time information and at least one API for obtaining the information are selected.

For example, the planner LLM determines an appropriate environment from among multiple external APIs, such as a web search API, a location search API, a weather search API, a code execution API, and a mathematics calculation API, and selects a required API by considering functionality, data characteristics, and real-time processing capability of each API. For example, for a query related to latest information, such as “What are the updated features of YOLO v5?”, the web search API is selected; for the query, “Please tell me where I can rent equipment for outdoor activities in Gwangju,” a location search API is selected; and for a problem involving mathematical calculation, a calculation API is selected.

In addition, the planner LLM analyzes temporal correlation between the query and a current point in time to ensure accuracy of real-time data and also calculates an appropriate data search scope.

Specifically, the planner LLM refers to current time information stored within the system to determine whether a user's query requires “real-time information,” “recent information,” or “year/period-based statistical information.” For example, when a query such as “how many home runs has Shohei Ohtani hit?” is input, the planner LLM determines that the question requests latest sports record data based on the current day or the previous day, and automatically sets a search scope in a form such as “search time: today” or “search time: yesterday.” On the other hand, when long-term and summary information is required, such as “Tell me about the trending fashion this year,” the planner LLM sets a search time on a range basis such as “Search time: this year” so that annual trend data is provided preferentially. In the process of automatically setting the time range as described above, the planner LLM comprehensively considers time expressions included in the query, event context, current date, and general time scales according to query topics (e.g., stock price fluctuations based on the current day, sports records based on the current day/previous day, trend information based on annual basis, etc.).

The API selected through this process is called in a form including a time filter (search scope) set by the planner LLM so that the server may respond only with data appropriate for the time range.

At step S304, real-time data is requested from a server using the selected API and obtained as an API response.

In step S304, the system sends an API request message generated by the planner LLM to a server, and the server receives the requested data (e.g., web search results, map-based location information, latest technical documentation, calculation results, weather, generated code, etc.) from an external data environment 303 and returns the requested data in real time. The returned data may be provided in a structured format such as JavaScript object notation (JSON), and the returned data is used as-is in subsequent processing steps.

At step S305, using the API response, a natural language response is generated and output through the second language model 304.

For instance, the second language model 304 may be configured as a chat LLM. While the second language model 304 is described as distinct from the first language model 302 in an embodiment of the present disclosure, the present disclosure is not limited thereto, and the first and second language models 302 and 304 may be implemented as a single language model. The second language model 304 reconstructs the structured data or search results retrieved by the first language model 302 (planner LLM) into natural language sentences that are easily understood by the user. The chat LLM organizes, summarizes, and interprets the response content and provides the results to the user in a natural and contextually appropriate form. For example, for a code generation request, the chat LLM outputs an executable code fragment; for a place search request, the chat LLM explains location information and recommended places; for a technical update request, the chat LLM organizes and provides a list of the latest features; and for a mathematical problem, the chat LLM explains a step-by-step calculation process and then presents the answer.

Through this, an embodiment of the present disclosure can provide more accurate and contextually appropriate real-time information with less computation resources by precisely analyzing the intent and information requirements inherent in user queries and comprehensively utilizing various external data environments (e.g., web search, map-based place information, weather information, code execution results, mathematical calculation results, etc.). Further, by parsing the keywords, temporal expressions, and task purposes of queries through the planner LLM to generate structured parameters and automatically setting search ranges that consider even temporal associations, an embodiment of the present disclosure may enable users to obtain sophisticated data search and analysis results using only natural language without the need to directly specify complex search conditions or instructions. In addition, by having the first language model and the second language model cooperate to proceed from real-time data collection to natural language response generation, various types of queries can be stably processed and integrated responses can be provided for both structured and unstructured data.

FIGS. 4A and 4B are a flowchart and a conceptual diagram for illustrating a process in which a first language model parses a query and classifies the type of the query to provide to a subsequent API selection step in a method for analyzing a type of the query through a first language model according to an embodiment of the present disclosure. The process in which a first language model parses a query and classifies the type of the query to provide to a subsequent API selection step may be performed in step S302.

At step S401, the first language model parses at least one of a keyword, a temporal expression, a data format requirement, and a task purpose included in the input query.

For instance, the first language model 302 divides or dissects a sentence written in natural language into token units, then estimates semantic roles by considering the part of speech, position, and relationship with surrounding words of each token, and detects parameter candidates such as target technology names, location information, time ranges, and numerical values to be used in calculations within the query. For example, as shown in FIG. 4B, when the query 401, “Find and summarize AI status-related documents written yesterday,” is input, the first language model 302 parses “AI status” as a keyword identifying content, “yesterday” as a temporal expression, and the “find and summarize documents” portion as “a task purpose of searching for and summarizing documents in the file system,” and based on this, generates a structured parameter set 402 having slots such as target, content, date, and location. In this case, the generated parameters may be mapped such that the target is “file,” the content is “AI status,” the date is “yesterday,” and the location is “null.” As another example, when the query, “What is Korea's medal ranking at the 2024 Paris Olympics?”, is input, the first language model 302 extracts “Paris Olympics,” “Korea,” and “medal ranking” as keywords, infers a time range representing the Olympic hosting period, and converts them into structured data storing multiple search sentences in array form in a field called “search_queries,” a search period such as ‘2024/07/26-2024/08/12’ in a “search_time” field, and a search target type such as “web” in a “search_target” field. These structured representations may be implemented in a data format of key-value pairs similar to JSON, and the first language model fills each parameter into the corresponding key, forming an input structure for function calls that may be u sed as-is in subsequent API calling steps. In this manner, the first language model 302 parses a keyword, a temporal expression, a data format requirement, and a task purpose expressed in natural language, extracts semantic elements of the query into an explicit parameter set, and organizes this in a structured format such as JSON, thereby converting the query into a machine-processable form.

At step S402, the first language model 302 uses the structured parameters and semantic information of the original query to classify the query into at least one of a plurality of predefined query types.

For example, a query that requires finding documents in the file system and performing summarization, such as “Find and summarize AI status-related documents written yesterday,” is classified as a “File Search and Summary (Function Calling-file)” type, and a query that adjusts device settings, such as “The screen is too bright, please lower the brightness,” is classified as a “Device Control (Function Calling-brightness_down)” type. On the other hand, a query with a task purpose not supported by the current system, such as “Please start wireless charging the laptop battery,” may be classified as a “NO_INTENT” or “Unsupported Function” type because valid parameters are not extracted according to the parsing results. In the case of the Olympic medal ranking example described earlier, after generating structured data with “search_queries,” “search_time,” and “search_target,” the first language model 302 determines that the query requires retrieving time-series sports data from the web and classifies the query into a “Web Search-based Statistical Query (Real-time Web Search)” type. In this manner, the first language model 302 refers to parameters extracted from the query and an internally defined query type dictionary to tag each query as one or a plurality of types such as code generation, file search, device control, web search, location search, mathematical calculation, or unsupported query, and stores the classification results for reference in the subsequent API selection step S303.

Through this, by automatically converting user queries written in natural language into structured parameters and query types, an embodiment of the present disclosure can improve the accuracy and efficiency of subsequent API selection and data processing with less computation resources. Furthermore, by clearly distinguishing between supportable and unsupportable functions and selecting an appropriate processing path, an embodiment of the present disclosure can perform a variety of service requests in a stable and consistent manner.

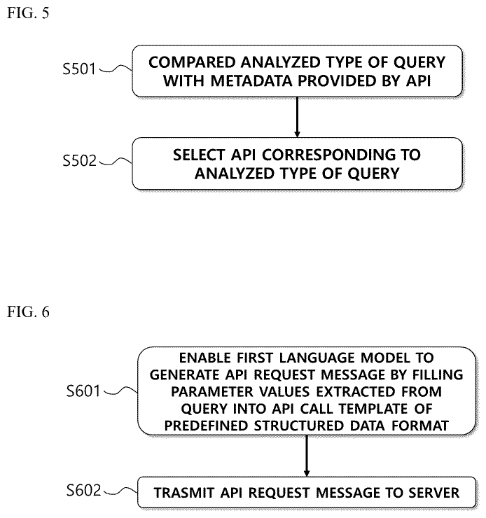

FIG. 5 is a flowchart for illustrating a process of selecting an API corresponding to the query type in a method for selecting a search scope and at least one API for acquiring real-time information based on the type of a query analyzed by a first language model according to one embodiment of the present disclosure. The process of selecting the API corresponding to the query type may be performed in step S303.

At step S501, the type of the analyzed query is compared with metadata provided by the API.

For example, the metadata of the API may be implemented as a metadata table including attribute information regarding a format of data that the API may provide (e.g., JSON, text, table structure, geographic coordinates, code snippets, etc.), an available data range (e.g., a domain range such as stock prices, news, technical documents, weather, maps, mathematical operation results, and supported language, region, and service ranges), response delay time (e.g., average response time, maximum allowable delay time, whether synchronous/asynchronous processing is performed), and an update cycle (e.g., real-time streaming, second-unit or minute-unit updates, daily or weekly updates, etc.). The first language model 302 refers to the structured query representation and query type tags (e.g., “web search-based latest information inquiry,” “place search,” “weather inquiry,” “code execution,” “mathematical calculation,” etc.) generated in steps S401 and S402 shown in FIG. 4 A and evaluates whether the query matches a data format, information domain, allowable response speed, and required recency level required by the query by comparing these with metadata of each API. For example, when a query type is classified as “real-time stock price inquiry” and query parameters require “current time point,” “numeric time series data,” and “second or minute-unit updates,” the first language model 302 assigns a high suitability score to a stock price API that provides a stock price data domain in the metadata, returns time series data in JSON format, is updated in second units or minute units, and has a short average response time. On the other hand, when the same query type is compared with metadata of a news search API or a general document search API, the calculated suitability score is low because a data format or update cycle does not match the required conditions. In this manner, the first language model 302 calculates and stores a matching score for each API by applying an internal score function that considers “whether data format matches,” “whether information domain matches,” “whether required response delay time is satisfied,” “suitability between recency requirements and update cycles”, and the like for each API. Here, the suitability calculation may be performed by any type of methods such as cosine similarity, weighted scoring-based matching, rule-based condition matching, or Bayesian inference, but is not limited thereto.

At step S502, an API corresponding to the analyzed type of the query is selected.

Specifically, the first language model 302 selects as candidates APIs that satisfy a predetermined threshold value or more among the previously calculated matching scores, and finally selects one API or a plurality of APIs having a highest score among them. For example, in the case of the query, “Tell me where outdoor activity equipment can be rented in Gwangju,” after being classified as a place search type, a place search API that supports location-based search, returns map coordinates, business names, and contact information, and is described in metadata as providing detailed place data for a specific region (Gwangju) is selected. As another example, the query, “Tell me what updated functions of YOLO v5 are,” is classified as a latest technical information inquiry type, and a web search API that performs web searches targeting technical documents, blogs, and official documents and updates an index in minute units or hour units is selected. In this manner, the first language model 302 comprehensively considers matching results between query types and API metadata, selects an API that best satisfies requirements of the analyzed query, and transmits a search scope (e.g., search_time, search_target, etc.) and parameters together with a selected API identifier to an API call step S304, thereby enabling the server to subsequently acquire appropriate real-time data through the corresponding API.

Through this, the system automatically selects the most suitable API for the data format and recency, information domain, and response speed required by the user's query, thereby reducing unnecessary API calls and enabling accurate and rapid real-time information acquisition. Further, by being based on matching between the semantic structure of the query and API metadata, the system can stably select the optimal data source for various types of queries, improving overall data processing efficiency and response quality.

FIG. 6 is a flowchart for illustrating a process of generating an API request message and transmitting the API request message to a server in a method for requesting real-time data from a server using a selected API to obtain an API response according to an embodiment of the present disclosure. The process of generating the API request message and transmitting the API request message to the server may be performed in step S304.

At step S601, the first language model 302 retrieves an API call template of a predefined structured data format based on parameters extracted from the query (e.g., search target entity, location information, time range, requested operation type, numerical values to be used in calculations, etc.) as described above in FIGS. 4 and 5.

The API call template may have a predefined framework conforming to specifications required by the API server, such as JSON, key-value structure, function call format, and the like, and the first language model 302 automatically fills parameter values extracted from the query into each field of the template to generate an API request message. For example, when a web search API is selected, a JSON structure such as {“search_queries”: [“Paris Olympics Korea medal ranking”], “search_time”: “2024/07/26-2024/08/12”, “search_target”: “web”} is generated, and when a file summary function call is required, a function-type request message such as SUMMARIZE(target=“file”, content=“AI status”, date=“yesterday”, location=null) is configured. In addition, the first language model may perform validity verification during the request message generation process by automatically checking for incorrect value insertion, missing fields, data format errors, and the like, so that the API server can process the request without errors.

At step S602, the generated API request message is transmitted to the server.

For example, at step S602, the first language model 302 automatically maps an endpoint URL, an authentication token, a request method (e.g., GET, POST), and header information (Content-Type, User-Agent, etc.) corresponding to the selected API and delivers a request packaged in a format suitable for the server. After receiving the request, the server queries necessary real-time data from external data environments (e.g., web search engines, map search servers, weather servers, code execution sandboxes, etc.) to generate a response, and the system receives the response data as-is so that the second language model 304 may reconstruct the response data into a natural language response in a subsequent step S305.

By automatically converting queries into structured API requests, an embodiment of the present disclosure may enable real-time data acquisition that accurately reflects a user's query intention. Furthermore, the first language model 302 may consistently perform extraction of query parameters, automatic completion of API call templates, and a server transmission process, thereby reducing or minimizing failures due to API selection errors or format mismatches and reliably supporting integration with various external data sources.

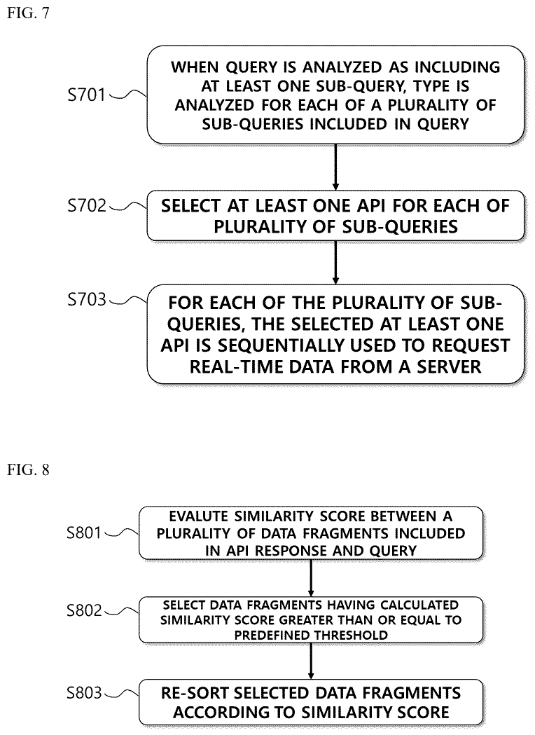

FIG. 7 is a flowchart for illustrating a process of obtaining real-time data from a server when an input query includes at least one sub-query by individually selecting an API for each sub-query and sequentially calling the API according to an embodiment of the present disclosure.

At step S701, when a query is analyzed as including at least one sub-query, a type for each of a plurality of sub-queries included in the query is analyzed.

This analysis step S701 may be performed in the query type analysis step S302 described above in FIG. 3, but is not limited thereto. The first language model 302 determines whether an input query comprises a plurality of semantic units, and when the query is analyzed as including at least one sub-query, separates each sub-query included in the query into independent analysis target units. The first language model 302 parses key keywords, temporal expressions, location information, data request formats, computational elements, and the like included in each sub-query to derive a purpose and requirements of each individual sub-query. For example, when the query, “Tell me about updated features of YOLO v5 and summarize related latest papers,” is provided, the first language model separates the query into two independent sub-queries of “YOLO v5 update feature inquiry” and “related latest paper summary” and separately identifies each query type.

At step 702, at least one API is selected for each of the plurality of sub-queries.

Step 702 may be performed in step S303 of selecting at least one API, but is not limited thereto. The first language model 302 analyzes conditions required for each sub-query, such as data type, information domain, recency level, processing format, and the like on a sub-query basis, and then individually matches the most appropriate API for the corresponding conditions. For example, when a first sub-query requires latest technical update information, a web search API may be selected, and when a second sub-query requires academic paper summarization, a literature search API or a PDF analysis API may be selected. By selecting different API sets for each sub-query in this manner, accurate information can be acquired even in complex queries where a plurality of sub-queries are present simultaneously.

At step S703, for each of the plurality of sub-queries, the selected at least one API is sequentially used to request real-time data from a server.

Step S703 may be performed in step S304 of requesting real-time data and obtaining the real-time data as an API response, but is not limited thereto. Each sub-query is converted into an independent API request message based on structured parameters of the corresponding query and a selected API call template. Thereafter, the system preferentially calls an API corresponding to a first sub-query to obtain related data from the server, and subsequently calls APIs sequentially in the same manner for second and subsequent sub-queries. This sequential processing method may also be applied when there are dependency relationships between sub-queries (e.g., when a first API result is used as a second API parameter). For example, when a query, “Tell me the current weather in Seoul, and recommend an outdoor activity suitable for the weather conditions,” is input, the system first calls a weather API to obtain real-time weather information, and then performs sequential information acquisition by calling an activity recommendation API including the obtained weather information as a parameter.

Through this, an embodiment of the present disclosure can stably acquire real-time data that is accurate and suitable for the purpose even in complex query structures. Furthermore, an embodiment of the present disclosure can organically process sub-queries while maintaining a step-by-step data flow even when there is a precedence dependency relationship between the sub-queries, thereby implementing an advanced data acquisition system that understands and executes a user's multi-step requirements.

FIG. 8 is a flowchart illustrating a process of using an API response in a method in which a second language model generates a natural language response using the API response according to an embodiment of the present disclosure.

At step S801, similarity scores between a plurality of data fragments included in an API response and a query are evaluated.

Here, the API response may mean entirety of structured or unstructured data returned by a selected API, such as web search results, map information, news documents, technical documents, code execution results, numerical data, metadata lists, and the like, and data fragments may mean minimum information units separated by semantic units in the API response (e.g., a single sentence unit, a paragraph block, an entity record, a key-value pair, a JSON field, a token sequence, etc.).

Before being input to a second language model 304, semantic proximity between each data fragment and a user query is measured using a predefined similarity calculation module, and a similarity score is calculated. The similarity score may be calculated using any type of calculation methods such as cosine similarity, Euclidean distance, weighted scoring, Best Matching 25 (BM25), semantic text similarity (STS), or a deep learning-based cross-encoder method, but the present disclosure is not limited thereto.

At step S802, data fragments having the calculated similarity score greater than or equal to a predefined threshold are selected.

In step S802, threshold-based filtering may be performed in order to remove noise data, irrelevant data, duplicate information, and the like and to leave only information that directly corresponds to the intent of the user's query. For example, when an API response to a query asking for a specific technical update returns an entire blog post, the system selects and retains only sentences or paragraphs that are directly related to “update features,” “change history,” or “new version features.”

At step S803, the selected data fragments are re-sorted according to similarity score.

In step S803, the system ranks each data fragment based on its score and arranges data fragments so that the most relevant fragment is most preferentially reflected to natural language response generation. To the re-sorting process, not only simple score-based sorting, but also weighted sorting that considers logical coherence among data fragments, chronological order, thematic relevance, and the like may be applied. These sorting results are input to the second language model 304 and used as core evidence for final natural language response generation.

Through this, unnecessary information with low relevance to the user's query can effectively removed from the API response, and the second language model 304 can receive only core data that has been selected and sorted based on similarity, thereby generating accurate and contextually appropriate natural language responses.

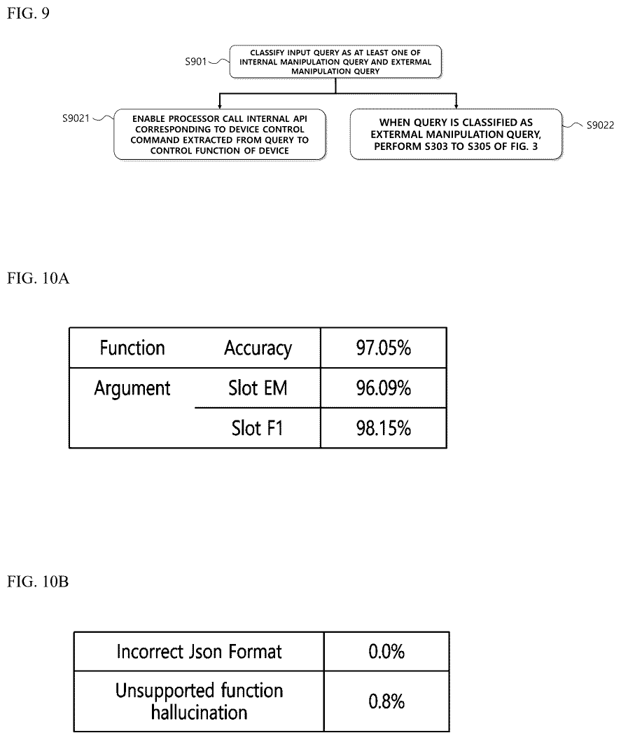

FIG. 9 is a flowchart for illustrating an operating procedure of a system that processes both internal manipulation queries requiring device function control and external information queries requiring external data acquisition according to an embodiment of the present disclosure.

At step S901, an input query is classified as at least one of an internal manipulation query and an external information query. Step S901 may be performed in the query type analysis step S302 described above with respect to FIG. 3, although not required.

Here, the internal manipulation query may refer to a command for controlling functions of the device itself (e.g., device power control, screen brightness adjustment, volume adjustment, communication setting changes, or application execution), and include commands that request device internal settings, function calls, device state changes, and the like, such as “Turn off the power,” “Increase screen brightness,” “Turn off Wi-Fi,” and “Set alarm for 7 a.m.” The external information query may refer to a query that requires obtaining information from a server or network external to a device, and include information search and retrieval-based queries such as “Tell me tomorrow's weather in Seoul,” “Find the latest AI technology news,” “Recommend a nearby cafe,” and “Tell me the result of 386 multiplied by 17.”

At step S9021, when the query is classified as an internal manipulation query, the processor calls an internal API corresponding to the device control command extracted from the query to control the function of the device.

An internal manipulation query processing process may be implemented in a form where a first language model is mounted in an on-device environment, and the first language model parses an input command to identify a manipulation target function (e.g., screen, audio, sensor, wireless communication module, etc.) and operation parameters, and then calls an internal API provided by a device OS or firmware layer to directly control the function. Through this, not only simple setting changes but also complex manipulations (e.g., “Turn on Bluetooth and connect earphones”) can be performed with natural language commands alone.

On the other hand, at step S9022, when the query is classified as an external information query, steps S303 to S305 of FIG. 3 are performed.

In other words, for an external information query, a search scope is set to obtain real-time information and at least one API is selected, then real-time data is requested from a server using the selected API and obtained as an API response, and finally a natural language response is generated and output through the second language model in a series of processes. This procedure is applied identically to the above-described external information-based response generation process, and API selection appropriate for the query content, response data processing, and natural language conversion are performed successively.

Through this, an embodiment of the present disclosure may enable a user to receive a universal service that can process various requirements of device function control and information retrieval using only natural language through a single interface.

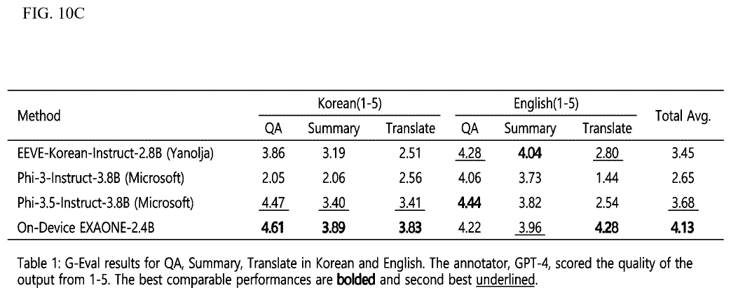

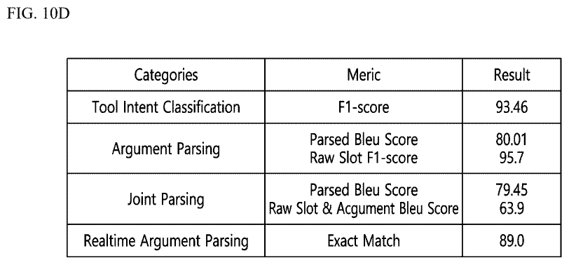

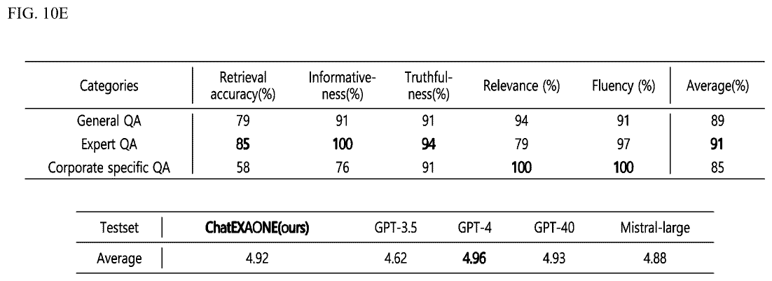

FIGS. 10A to 10E show test results of verifying the effectiveness of an embodiment of the present disclosure.

FIG. 10A shows the prediction accuracy of a function calling experiment.

Through this, performance for accurately identifying the functions and arguments necessary to execute natural language queries requested by users was measured. This shows the ability of the first language model to accurately identify query intent, select an appropriate API, and extract necessary parameters. According to the test result shown in FIG. 10A, the first language model according to an embodiment of the present disclosure can identify functions and parameters required for API calls with high accuracy even in complex natural language queries, thereby reducing or minimizing unnecessary API call errors and very efficiently initiating a real-time information acquisition process.

FIG. 10B shows the accuracy of an output structure through function calling.

The validity and accuracy of the structured output generated by the first language model for API calls (e.g., request messages in JSON format) were evaluated. The structured API request messages generated by the first language model exhibited high accuracy validity, which confirmed that the API server is capable of processing the requests without errors.

FIG. 10C shows the test results of individually measuring the performance of question answering (QA), summarization, and translation.

These results show that an embodiment of the present disclosure is not limited to a particular domain, but is capable of processing various types of queries (FIG. 4) reliably and outputting a final response with high accuracy.

FIG. 10D shows the test results of comprehensively measuring the performance of the planner LLM (the first language model) to select an appropriate tool (e.g., API) for a complex query involving multi-step tasks and to accurately extract arguments (e.g., parameters) suitable for the tool.

The test results of FIG. 10D show that an embodiment of the present disclosure exhibits high accuracy in all areas of tool intent classification, argument parsing, joint parsing, and real-time argument parsing, and is furthermore capable of accurately identifying the intent inherent in a user query to select an optimal API and reliably extract required parameters.

FIG. 10E shows the test results of objectively evaluating the quality (e.g., Quality, Coherence, Accuracy, etc.) of responses using a high-performance external model (e.g., a general-purpose LLM) such as GPT-4 as a judge for the output according to the present invention.

According to the test results of FIG. 10E, an embodiment of the present disclosure showed high retrieval accuracy (85%) and factuality (94%) in expert QA, which demonstrates the strength of an embodiment of the present disclosure in providing reliable information based on real-time data obtained through external APIs. In addition, the G-Eval evaluation results showed that the average score (4.92) of an embodiment of the present disclosure {ChatEXAONE(ours)} was higher than or equal to that of competing models, demonstrating that an embodiment of the present disclosure has very high quality even with reference to external high-performance models.

A method of acquiring data using a language model according to some embodiments of the present disclosure may be implemented by the system described with reference to FIG. 1.

The AI models according to certain embodiments of the present invention may be controlled, executed, learned, driven, or the like by one or more processors, and accordingly, at least one of execution, learning, and driving of the AI models may be performed by at least one processor. Furthermore, the AI models may be stored in a memory, and the feature data according to some embodiments of the present disclosure may also be stored in the memory.

Meanwhile, the disclosed embodiments may be implemented in the form of a recording medium that stores instructions executable by a computer. The instructions may be stored in the form of program code, and when executed by a processor, may generate program modules to perform the operations of the disclosed embodiments. The recording medium may be implemented as a computer-readable recording medium.

Computer-readable recording media include all types of recording media storing instructions that may be decoded by a computer. For example, there may be read-only memory (ROM), random access memory (RAM), magnetic tape, magnetic disk, flash memory, optical data storage device, and the like.

The disclosed embodiments have been described above with reference to the accompanying drawings. Those skilled in the art to which the present disclosure pertains will understand that the present disclosure may be practiced in forms different from the disclosed embodiments without departing from the technical spirit or essential features of the present disclosure. The disclosed embodiments are illustrative and should not be construed as limiting.

What is claimed is:

1. An artificial intelligence system, comprising:
at least one memory configured to store instructions;
at least one server; and
at least one processor configured to execute one or more of the instructions to perform operations comprising:
receiving a query generated based on a user query or a system event;
analyzing a type of the query by a first language model;
selecting, by the first language model, a search scope and at least one application programming interface (API) for obtaining real-time information according to the analyzed type of the query;
requesting real-time data to the server using the selected API and obtaining the real-time data as an API response from the server; and
outputting a natural language response through a second language model using the API response.

2. The artificial intelligence system of claim 1, wherein the analyzing of the type of the query includes causing the first language model to parse at least one of a keyword, a temporal expression, a data format requirement, or a task purpose included in the query and to categorize the query into at least one of a plurality of predefined query types.

3. The artificial intelligence system of claim 1, wherein the selecting of the at least one API includes selecting an API corresponding to the analyzed type of the query by comparing the analyzed type of the query with at least one of a data format, an available data range, a response delay time, or an update cycle included in metadata provided by the API.

4. The artificial intelligence system of claim 1, wherein the requesting of the real-time data to the server using the selected API includes causing the first language model to generate an API request message by filling parameter values extracted from the query into an API call template of a predefined structured data format and to transmit the API request message to the server.

5. The artificial intelligence system of claim 1, wherein:
the analyzing of the type of the query includes, when the query includes one or more sub-queries, analyzing a type for each of the one or more sub-queries included in the query; and
the selecting of the at least one API includes selecting the at least one API for each of the one or more sub-queries; and
the requesting of the real-time data to the server includes requesting the real-time data to the server by sequentially using the at least one API selected for each of the one or more sub-queries.

6. The artificial intelligence system of claim 1, wherein the outputting of the natural language response through the second language model using the API response includes:
evaluating similarity scores between a plurality of data fragments included in the API response and the query;
selecting one or more data fragments having the similarity scores greater than or equal to a predefined threshold among the plurality of data fragments; and
re-sorting the selected one or more data fragments according to the similarity scores.

7. The artificial intelligence system of claim 1, further comprising a device including another processor and another memory,
wherein:
the analyzing of the type of the query includes classifying the query as at least one of an internal manipulation query requiring control of functions of the device or an external information query requiring acquisition of external data,
the another processor is configured to, when the query is classified as the internal manipulation query, control the functions of the device by calling an internal API corresponding to a command for controlling the device extracted from the query, and
the another processor is configured to, when the query is classified as the external information query, select the search scope and the at least one API for obtaining the real-time information, request the real-time data to the server and obtain the API response from the server, and output the natural language response through the second language model.

8. The artificial intelligence system of claim 7, wherein the command for controlling the device includes at least one of device power control, screen brightness adjustment, volume adjustment, communication setting change, or application execution.

9. A computerized method comprising:
receiving a query generated based on a user query or a system event;
analyzing a type of the query by a first language model;
selecting, by the first language model, a search scope and at least one application programming interface (API) for obtaining real-time information according to the analyzed type of the query;
requesting real-time data to the server using the selected API and obtaining the real-time data as an API response from the server; and
outputting a natural language response through a second language model using the API response.

10. The computerized method of claim 9, wherein the analyzing of the type of the query includes causing the first language model to parse at least one of a keyword, a temporal expression, a data format requirement, or a task purpose included in the query and to categorize the query into at least one of a plurality of predefined query types.

11. The computerized method of claim 9, wherein the selecting of the at least one API includes selecting an API corresponding to the analyzed type of the query by comparing the analyzed type of the query with at least one of a data format, an available data range, a response delay time, or an update cycle included in metadata provided by the API.

12. The computerized method of claim 9, wherein the requesting of the real-time data to the server using the selected API includes causing the first language model to generate an API request message by filling parameter values extracted from the query into an API call template of a predefined structured data format and to transmit the API request message to the server.

13. The computerized method according to claim 9, wherein:
the analyzing of the type of the query includes, when the query includes one or more sub-queries, analyzing a type for each of the one or more sub-queries included in the query; and
the selecting of the at least one API includes selecting the at least one API for each of the one or more sub-queries; and
the requesting of the real-time data to the server includes requesting the real-time data to the server by sequentially using the at least one API selected for each of the one or more sub-queries.

14. The computerized method of claim 9, wherein the outputting of the natural language response through the second language model using the API response includes:
evaluating similarity scores between a plurality of data fragments included in the API response and the query;
selecting one or more data fragments having the similarity scores greater than or equal to a predefined threshold; and
re-sorting the selected one or more data fragments according to the similarity scores.

15. The computerized method of claim 9, wherein the analyzing of the type of the query includes classifying the query as at least one of an internal manipulation query requiring control of functions of a device including a processor and a memory or an external information query requiring acquisition of external data,
when the query is classified as the internal manipulation query, the processor controls the functions of the device by calling an internal API corresponding to a command for controlling the device extracted from the query, and
when the query is classified as the external information query, the processor selects the search scope and the at least one API for obtaining the real-time information, requests the real-time data to the server and obtains the API response from the server, and outputs the natural language response through the second language model.

16. The computerized method of claim 15, wherein the command for controlling the device includes at least one of device power control, screen brightness adjustment, volume adjustment, communication setting change, or application execution.

17. A non-transitory computer-readable storage medium storing instructions that, when executed by one or more processors, cause the one or more processors to perform operations comprising:
receiving a query generated based on a user query or a system event;
analyzing a type of the query by a first language model;
selecting, by the first language model, a search scope and at least one application programming interface (API) for obtaining real-time information according to the analyzed type of the query;
requesting real-time data to the server using the selected API and obtaining the real-time data as an API response from the server; and
outputting a natural language response through a second language model using the API response.

18. The non-transitory computer-readable storage medium of claim 17, wherein the analyzing of the type of the query includes causing the first language model to parse at least one of a keyword, a temporal expression, a data format requirement, or a task purpose included in the query and to categorize the query into at least one of a plurality of predefined query types.

19. The non-transitory computer-readable storage medium of claim 17, wherein the selecting of the at least one API includes selecting an API corresponding to the analyzed type of the query by comparing the analyzed type of the query with at least one of a data format, an available data range, a response delay time, or an update cycle included in metadata provided by the API.

20. The non-transitory computer-readable storage medium of claim 17, wherein the requesting of the real-time data to the server using the selected API includes causing the first language model to generate an API request message by filling parameter values extracted from the query into an API call template of a predefined structured data format and to transmit the API request message to the server.
